(19) United States
(12) Patent Application Publication
(10) Pub. No.: US 2023/0334443 A1
(43) Pub. Date: Oct. 19, 2023

(54) AUGMENTED NON-FUNGIBLE TOKEN (NFT) PLATFORM, SYSTEM, AND METHOD OF USE THEREOF

(71) Applicant: Terrance Sullivan, Oak Park, MI (US)

(72) Inventor: Terrance Sullivan, Oak Park, MI (US)

(21) Appl. No.: 18/302,739

(22) Filed: Apr. 18, 2023

Related U.S. Application Data
(60) Provisional application No. 63/332,049, filed on Apr. 18, 2022.

(51) Int. Cl. G06Q 20/06

(52) U.S. Cl. CPC G06Q 20/065; G06Q 2220/00

(57) ABSTRACT

An online platform configured to facilitate the minting and display of Non-fungible tokens (NFTs) equipped with augmentations which depict live data via one or more embedded overlays on the graphical representation of the NFT when viewed from the platform. Augmentations embody pertinent data including, but not limited to spot stock quotes, cryptocurrency prices, weather, sports scores, commodity spot prices, and other data. The data of the augmentations is ported from onboarded datasets which are written into the block of the blockchain on which the NFT is stored via the metadata of the blockchain. Executable code may also be included, facilitating the execution of web-links and program initiations from interaction with the dataset overlay on the displayed NFT while displayed on the platform.

### CONTINUITY

This application is a non-provisional application of provisional patent application No. 63/332,049, filed on Apr. 18, 2022, and priority is claimed thereto.

### FIELD OF THE PRESENT INVENTION

The present invention relates to the field of digital blockchain assets, and more specifically relates to a platform and system configured to facilitate the creation and display of non-fungible tokens (NFTs) which are augmented with real-world data presented in real time within the graphical representation of the NFTs.

### BACKGROUND OF THE PRESENT INVENTION

A vast majority NFTs present on conventional marketplace platforms offer very little, if any, interactivity with the NFTs themselves. Platforms such as OpenSea™ provide the capacity for users to bid on and/or purchase NFTs, as well as view them within a user's portfolio; however, the NFTs offer little more than standard static graphics, animated graphics, or short looping videos. None of the NFTs on any present platform provide the capacity for the display of live data within the construct of the NFT itself, and data present on the block (of the blockchain) for the asset is usually limited solely to metadata of the digital image instantiation of the NFT, as well as a URI/URL link to a permanent server at which the digital image/animation/video may be viewed from any internet browser. Many users wish that their NFTs could be more interactive, or reflect/provide real-time data. For example, if an NFT of a popular baseball team could be configured to depict the score of a current game happening in real-time, the owner of the NFT would get more utility out of their purchase, ultimately making ownership of the NFT more enjoyable.

If there were a way in which NFTs could be crafted with more usable features, including but not limited to the display of real-time data, executable code, and similar interactive elements, owners would get more meaningful use out of NFT ownership, and the popularity of such digital assets would be increased.

Thus, there is a need for a platform and method of use thereof for the minting and exhibition of NFTs equipped with additional interactive features. Such a platform is preferably configured to enable NFT creators to implement such features into the blockchain data of the NFT itself, the data being solely usable when the NFT is viewed on the platform itself.

### SUMMARY OF THE PRESENT INVENTION

The present invention is a NFT platform and marketplace designed to facilitate the creation and exhibition of specially-equipped NFTs which have been designed to combine with other digital elements such as live data or executable code, referenced as ‘augmentations’ to form a unique digital experience. The platform facilitates the depiction of dynamic data, disposed in static (or semi-static frames), functioning as proprietary overlays to digital media (.GIF, image files, video files, etc.) solely configured to be experienced on the specific platform of the present invention by a user on a computer or mobile device.

The augmentations, present as data sets, are mapped to logical locations on the visual representation of the media file, the coordinate positions of the data set fields being embedded into the minted NFT in accordance with metadata parameters informed to the blockchain of the minted asset. Types of datasets available and envisioned include concepts such as real-time weather, stock quotes, cryptocurrency spot prices, sports scores, and similar pertinent information. Executable code may also be incorporated to enable portions of the depiction of the NFT to function as buttons configured to launch programs or to direct the user to linked websites, domains, file servers, etc.

The following brief and detailed descriptions of the drawings are provided to explain possible embodiments of the present invention but are not provided to limit the scope of the present invention as expressed herein this summary section.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 depicts an example of an NFT minted and displayed on the platform of the present invention, equipped with augmentations.

FIG. 2 exhibits a flow chart detailing the process of use of the present invention in the minting, sale, and exhibition of an NFT on the platform of the present invention.

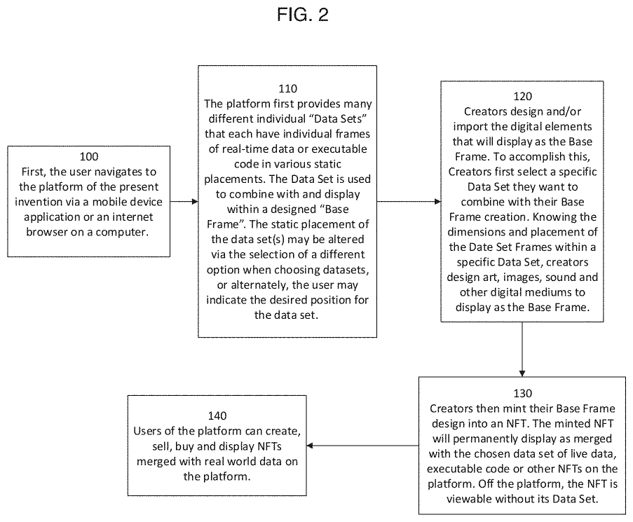

### DETAILED DESCRIPTION OF THE PREFERRED EMBODIMENT

The present specification discloses one or more embodiments that incorporate the features of the invention. The disclosed embodiment(s) merely exemplify the invention. The scope of the invention is not limited to the disclosed embodiment(s).

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to effect such feature, structure, or characteristic in connection with other embodiments whether or not explicitly described.

The present invention is a platform and system for the creation and interactive exhibition of NFTs (10). The present invention is preferably accessible to users on a mobile device application as well as a web-based platform. NFTs minted and depicted on the platform of the present invention are augmented with additional features, referenced as augmentations (20), differentiating them from conventional NFTs present on other conventional platforms and marketplaces. Each augmentation (20) is preferably delineated in the metadata of the minted NFT (10) and is stored on the blockchain, along with the conventional URI/URL link to the hosted digital image, digital animation, or video file.

The NFT (10) of the present invention equipped with such augmentation(s) (20) is colloquially referred to as an “Augmintable.” Augmentations (20) envisioned include the depiction of live data such as sports scores, stock prices, cryptocurrency spot prices, commodity spot prices, news headlines, and other similar data. Additionally, augmentations (20) may include executable code and/or embedded links such that, upon being clicked or tapped by a user, a program/app may run, or a website may be launched within a web browser.

Each minted NFT (10) of the present invention is equipped with at least one data set which is present atop a base frame which contains the graphical representation of the underlying digital image, digital animation, or digital video file.

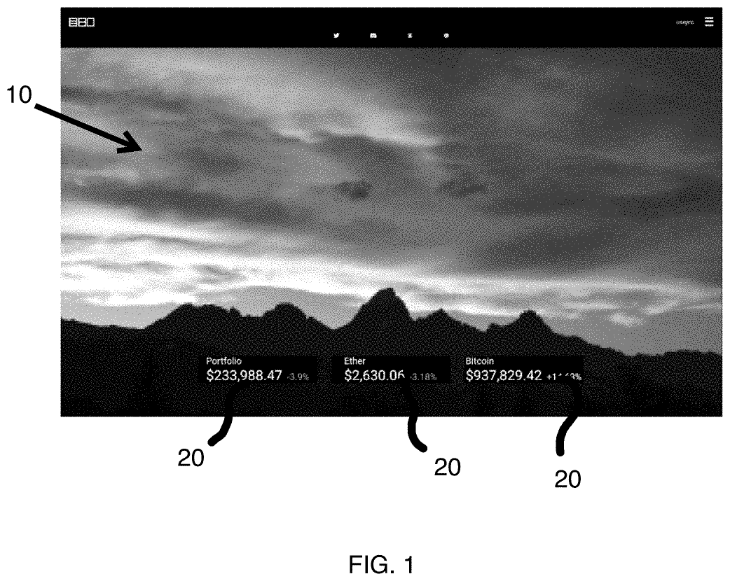

The general process of use of the system and platform of the present invention, as outlined in FIG. 1, is preferably as follows:
1. First, the user navigates to the platform of the present invention via a mobile device application or an internet browser on a computer. (100)
2. The platform first provides many different individual “Data Sets” that each have individual frames of real-time data or executable code in various static placements. The Data Set is used to combine with and display within a designed “Base Frame”. The static placement of the data set(s) may be altered via the selection of a different option when choosing datasets, or alternately, the user may indicate the desired position for the data set. (110)
3. Creators design and/or import the digital elements that will display as the Base Frame. To accomplish this, Creators first select a specific Data Set they want to combine with their Base Frame creation. Knowing the dimensions and placement of the Date Set Frames within a specific Data Set, creators design art, images, sound and other digital mediums to display as the Base Frame. (120)
4. Creators then mint their Base Frame design into an NFT. The minted NFT will permanently display as merged with the chosen data set of live data, executable code or other NFTs on the platform. Off the platform, the NFT is viewable without its Data Set. (130)
5. Users of the platform can create, sell, buy and display NFTs merged with real world data on the platform. (140)

The essence of the concept of the present invention is the “Minting” of a unique digital creation that combines and displays on the EBO Platform with a specific set of data. Therefore: “Unique Digital Creation+Live Data or Executable Code×Minting=Augmintables.” To successfully accomplish the minting/combining of the unique digital creation with a specific set of data, the unique digital creation must be designed with 2 extremely important factors incorporated into its design concept: 1. The unique digital creation must be designed with accuracy to accommodate the positions of the data frames that will combine with the unique digital creation as an Augmintable. 2. The unique digital creation should be designed to, on its own (without being combined with data) have a standalone completeness to its interpretation.

As such, users should always start by selecting the data set that they wish to incorporate into their creation. The user will then have the exact positions of the “Data Frames” of the data set(s) and the data content they display on the EBO Platform. Users are advised to design their creations to precisely incorporate the data set that will be minted with their Augmintable NFT (10).

Secondly, users should not design their unique digital creation with empty holes or empty spaces where the Data Frames are to be positioned. The unique digital creation will display with the Data Set it is minted with as an Augmintable on the platform of the present invention only. Away from the platform, NFTs crafted as Augmintables do not display data. Therefore, Augmintables designed with empty spaces or empty holes would not have a completeness or the ability to stand alone when displayed away from the platform. Thus, it is critical to design a complete concept that will, as an Augmintable, have a digital layer of data that will cover specific areas of the design while still remaining a desirable artistic creation when the data set is not present.

It is highly recommended that, for any unique digital creation, to have value and completeness both on the platform of the present invention as an Augmintable or displayed elsewhere as a standard NFT without data, to NEVER design your unique digital creation with empty spaces or empty holes where the Data Frames will be positioned on the EBO Platform.

In brief, users should follow these three simple steps to create Augmintables on the platform of the present invention:

Creation Step 1:

Choose an Augmintables Data Set
Data Sets are made of Data Frames. The Data Frames, that make up a Data Set, have a static position within a 16:9 aspect ratio framework. Data Frames display live data, executable code or other Web3 functionality. The unique digital creation will permanently Mint with the Data Set one chooses.
   a. Choose a Data Set with Data Frames that will display the data one desires to combine with your unique digital creation.
   b. Choose a Data Set with Data Frames that are positioned in the areas(s) that one desires to incorporate into the design of their unique digital creation.
   c. Download the Data Set Template of the Data Set you choose, to use as a precise guide of Data Frame placement. Data Set Templates allow one to design their unique digital creation and Mint Augmintables with absolute precision.

Creation Step 2:

Design Your Unique Digital Creation
After choosing a Data Set and downloading the Data Set Template, the creation of an Augmintable begins.
   a. Use the Data Set Template to design and arrange the elements of the unique digital creation within the 16:9 aspect ratio while incorporating the Data Frame placements and the live data elements that will display as an Augmintable.
   b. Do not leave empty holes (blank, black, white, or transparent spaces), empty spaces or intentionally undesigned areas in your design where the Data Frame placements are located. Although that area will be covered by the Data Frames on the EBO Platform as an Augmintable, the creation, when displayed elsewhere, will display without the data frames and having empty spaces in the design will make it less desirable.
   c. Design the Augmintables with the full power of digital creation. Each unique digital creation must have a 16:9 aspect ratio and can have the following file size and file formats:
   Max File Size: 100 MB
   Supported File Formats: gif, jpeg, png, svg or mp4
   (svg or mp4 are the recommended file types for the highest quality presentation of Augmintables)

Creation Step 3: Mint Augmintables
Once the user has completed the design of their unique digital creation they can then upload the digital file, select the Data Set, preview their Augmentable, and add the following details as metadata:
   Name/Title of Augmintable
   Description of Augmintable
   Custom Search Tags
   Number of Editions
   Secondary Sale Royalties
   License Type

Creation Step 4: Confirming transaction and Paying Fees
Once the user has uploaded their digital file, selected the Data Set, previewed their Augmintable and completed all of the required details, the user then selects the “Mint” button and confirms the Mint transaction in their Metamask wallet, similar connected wallet, or account synced with WalletConnect. Creators are responsible for paying all Ethereum network gas fees associated with Minting Augmintables.

Augmintables are ERC-721 tokens created on the Ethereum blockchain network with their data files stored on IPFS. At present, in order to mint Augmintables, users need to have either an Augmintables Creator Token (ACT) or 500 $EBO Tokens in their Ethereum account synced to EBO.io. Upon navigating to an Augmintable on the platform of the present invention, the digital creation is shown, along with information pertaining to the tools with which it was created. Users can view a history of sales, royalties, editions, the minted date, license type, transaction history, and purchasing options. It should be noted that some NFTs (10) minted as augmintables on the platform of the present invention may have live sound and video. Presently, a limit is imposed on the number of editions of a single augmentable. The limit may be amended in future iterations of the platform of the present invention; however, the limit is presented static at 10,000 editions of a single augmentable may be made.

It should be noted that some embodiments of the present invention are configured for use and display in Augmented Reality (AR) and/or Virtual Reality (VR) spaces. In such embodiments, the augmentations of the NFTs (10) of the platform of the present invention may be equipped with additional interactive features as pertinent to the environment in which they are displayed. Further, it should be understood that these embodiments are therefore depicted within aninstantiation of the platform of the present invention within the AR/VR space to facilitate the depiction of, and interaction with the augmentations (20). Alternately, the NFTs (10) of the present invention may be under license to be depicted with their augmentations (20) intact and usable on AR/VR platforms and spaces in collaboration with the platform of the present invention.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A system for viewing, trading, minting, and augmenting non-fungible tokens (NFTs) comprising:
a platform, said platform hosted to the internet by at least one server;
an NFT creation application, said NFT creation application configured to mint NFTs based on a static or dynamic image;
wherein said NFT creation application is disposed on and accessible from said platform;
wherein said NFT creation application enables dynamic information to be superimposed within metadata of the NFT upon minting the NFT from the static or dynamic image; and
wherein the minted NFT exhibits live sound and video.
